(19) United States
(12) Patent Application Publication
(10) Pub. No.: US 2004/0193771 A1
(43) Pub. Date: Sep. 30, 2004

(54) Method, apparatus, and system for processing a plurality of outstanding data requests

(76) Inventor: Sharon M. Ebner, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/401,574

(22) Filed: Mar. 31, 2003

(51) Int. Cl. G06F 13/36

(52) U.S. Cl. 710/306

(57) ABSTRACT

A method, apparatus, and system for processing a plurality of outstanding data requests from an expansion device connected to a computer system. The processing of one data request may commence before a previous request has been fully processed. Multiple data requests may be fetched from the computer system and fulfilled in an overlapping fashion. Data from a subsequent data request may be fetched prior to completion of the data return for a previous request. A record of each outstanding data request and returned requested data is stored. The returned requested data is returned to the expansion device in the order in which the requested data was requested.

### FIELD OF THE INVENTION

The present invention relates generally to communication between an expansion device and system resources, and more particularly, to a method, apparatus, and system for processing a plurality of outstanding data requests from an expansion device for data from system resources.

### BACKGROUND OF THE INVENTION

Expansion devices attached to computer systems communicate with the rest of the computer system via buses operating on protocols such as peripheral component interconnect (PCI) and industry standard architecture (ISA). Example expansion devices include input/output (I/O) cards, video cards, network cards, sound cards, and storage devices.

Expansion devices access system resources through a chip called an I/O bridge chip. The main task of the I/O bridge chip is to transmit data between expansion devices and system resources. The bridge chip retrieves the data requested by the expansion device, and drives the data to the card.

Traditional expansion device communication protocols prevented expansion devices from having no more than a single outstanding request for one data location, without specifying the size of the data block needed. A typical traditional expansion device makes a request for data from a single location, and the I/O bridge chip fetches and returns data starting at the requested location and continuing sequentially through memory, until the expansion device sends a request for the I/O bridge to stop. Recently developed expansion device communications protocols, such as PCI-X, allow an expansion device to have multiple outstanding data requests, and to specify the length of the data block needed for each request.

Though these new expansion device communication protocols allow an expansion device to have multiple outstanding data requests, it is still the case that only one data request is processed at a time, due to limitations in current I/O bridge chip technology. Such serial processing of data requests results in an inefficient utilization of I/O bus bandwidth, and accordingly slows the performance of expansion devices connected via such protocols. The bridge chip requires a variable amount of time to retrieve the next piece of data from the requested system resource and the time required can be relatively long. If processing is serial, the bridge chip must wait for the data from one request to be retrieved from the requested system resource and returned to the expansion device before processing the next data request. Accordingly, a need exists in the art for a method, apparatus, and system for processing a plurality of outstanding data requests from a connected expansion device, in which the processing of one data request can commence before a previous request has been fully processed.

### SUMMARY OF THE INVENTION

It is, therefore, an object of the present invention to provide a new and improved method of, apparatus and system for processing a plurality of outstanding data requests from an expansion device connected to a computer system, in which the processing of one data request can commence before a previous request has been fully processed.

According to one aspect of the present invention, plural outstanding data requests from an expansion device connected to a computer system are processed by sending each data request from an expansion device to an I/O bridge chip, which is connected to the rest of the computer system, wherein each data request includes indications of a location of the data requested and a length of the data requested. Data are fetched from other components in the computer system, according to each data request sent from the expansion device. Fetched data are returned from the computer system to the I/O bridge chip, according to the data fetches made. The results of each fetched data request are returned from the I/O bridge chip to the expansion device.

Another aspect of the present invention relates to an apparatus for processing plural outstanding data requests from an expansion device connected to a computer system. The apparatus is arranged for (1) fetching data from the computer system, according to each request received from the expansion device and (2) returning the results of each fetched data request to the expansion device.

A further aspect of the present invention concerns a system for maximizing utilization of communication bandwidth between an expansion device and a computer system to which it is connected, in which plural outstanding data requests are processed at the same time. This system comprises a computer system, an I/O bridge chip capable of processing a plurality of outstanding data requests from an expansion device connected to a computer system, and an expansion device. The I/O bridge chip is arranged for (1) fetching data from the computer system, according to each request received from the expansion device, and (2) returning the results of each fetched data request to the expansion device. Opposite ends of the I/O bridge chip are physically connected to the computer system and an expansion device bus. The expansion device bus operates on a protocol allowing connected expansion devices to have plural outstanding data requests, and to specify the length of each data request. The expansion device is physically connected to the expansion bus, and logically connected to the computer system via the I/O bridge chip.

Still other aspects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of the chip architecture of a preferred embodiment of the present invention;

FIG. 2 is a high level block diagram of the chip architecture of an alternative embodiment of the present invention; and

FIG. 3 is a transaction sequence diagram of an example sequence of transactions performed in accordance with an embodiment of the present invention.

### DETAILED DESCRIPTION

As used herein, the term “computer system” is used in place of “computer”. What is commonly referred to as a computer is in fact a system comprising at least one processor, main memory, and an input device. It optionally includes stable storage media such as a hard disk, removable storage devices such as a floppy drive or CD-ROM drive, output devices such as a monitor, additional input devices, and one or more expansion devices connected to the system via an expansion bus. While the depicted embodiments of the present invention are directed to data request devices connected to the system via the expansion bus, in fact the present invention could be directed to data requests by any computer system component which interfaces with the processor via an I/O bridge.

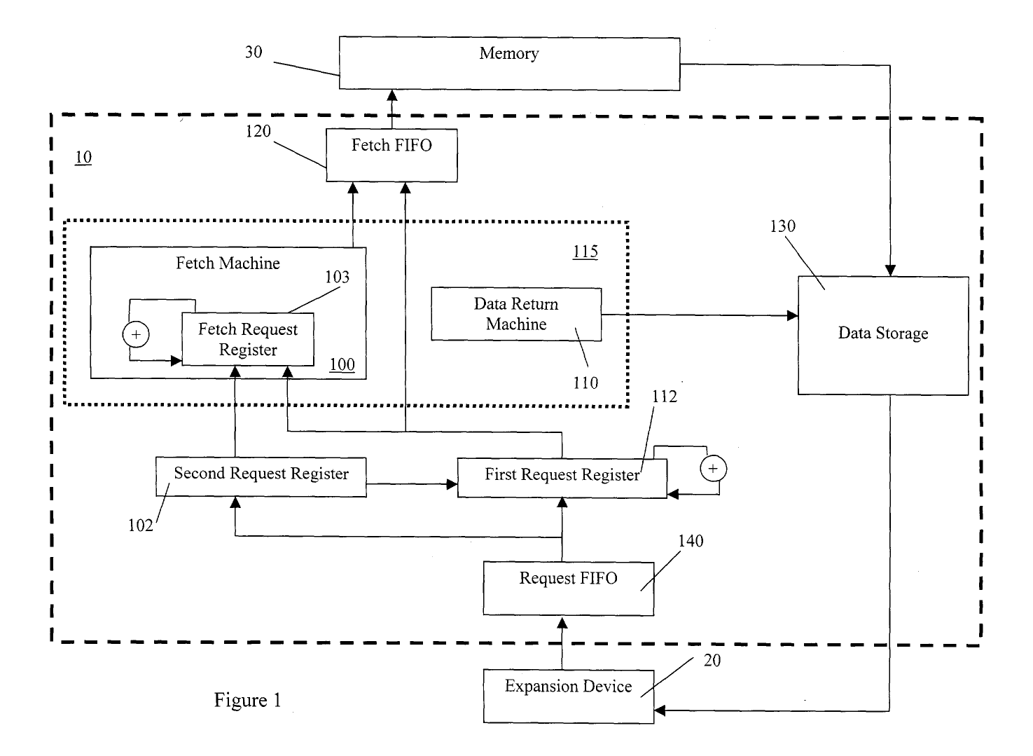

Refer first to FIG. 1 where a high-level block diagram of the chip architecture of the present invention is depicted. In a preferred embodiment of the present invention, an I/O bridge chip 10 interfaces between an expansion device 20 and a memory 30. In the preferred embodiment, the I/O bridge chip 10 is described as processing direct memory access (DMA) requests by the expansion device 20. Alternatively, the I/O bridge chip 10 can process other types of requests by the expansion device 20 for data from other system resources.

The expansion device 20 can have up to a fixed number of outstanding requests. The expansion device 20 sends data requests to I/O bridge chip 10. In the embodiment of FIG. 1, expansion device 20 has up to eight requests outstanding at one time, but it will be appreciated by those skilled in the art that alternatively expansion device 20 can have a different number of outstanding requests. Alternatively, expansion device 20 can be replaced with any other expansion device.

The connection between the expansion device 20 and the I/O bridge chip 10 is a PCI-X bus that makes multiple data requests at once, and specifies the length of each request. Alternatively, a different connection can be used.

The I/O bridge chip 10 includes a fetch machine 100 and a data return machine 110 that together form a state machine 115. The expansion device 20 sends DMA requests to the I/O bridge chip 10 that are stored in register 140, configured so each DMA request is stored in a request First In First Out (FIFO) queue. A FIFO queue is a queue in which the oldest item in the queue is the next item to be removed from the queue and supplied to the output of register 140.

Each request comprises the address of the first line of data requested from memory, and the length (in lines) of the request. In the preferred embodiment, a line is 64 bytes long, but it will be appreciated by those skilled in the art that this length can be varied with no impact on the present invention.

When a DMA request is received by the expansion device 20, the request is placed at the end of the queue of request FIFO 140. As described in more detail below, the state machine 115 when ready, removes the DMA request that is at the front of the queue in request FIFO 140. If no DMA requests are in progress, the request at the front of the queue is moved into the first request register 112. First request register 112 always holds the address of the next line of data to be returned from the I/O bridge chip 10 to the expansion device 20. The state machine 115 places the address of the first line of the request in the first request register 112 into the queue of fetch FIFO 120.

Requested addresses in the queue of fetch FIFO 120 are removed and sent to memory 30 by chip 10.

If the DMA request is longer than one line, the request comprised of the address of the second line of the DMA request in the first request register 112 and the corresponding request length (i.e. the length of the DMA request in the first request register 112 minus 1) is loaded into the fetch request register 103. For example, if a request of four lines is removed from the queue of request FIFO 140, the address of the second line in the request is loaded into the fetch request register 103, along with bits indicating the request includes three additional lines, i.e., a length of three (3).

The fetch machine 100 then fetches data, according to the values in the fetch request register 103. While the length of the request in the fetch request register 103 is greater than zero, the fetch machine 100 places the address of the request in the fetch request register 103 into the queue of fetch FIFO 120. If the length of the request in the fetch request register 103 is greater than zero, the fetch machine 100 decrements this length by one, and increments the address of the request in the fetch request register 103 to the address of the next line of memory. When the length of the request in the fetch request register 103 reaches zero, this is the signal that all lines of the request have been fetched.

If there is already a DMA request in progress when the state machine 115 removes the DMA request at the front of the queue of request FIFO 140, the request is loaded into a second request register 102.

When the fetch machine 100 finishes fetching a request, machine 100 checks if there is a DMA request in the second request register 102. If there is a request in the second request register 102 when machine 100 finishes fetching a request, the request is loaded into the fetch request register 103. The fetch machine 100 then fetches data, according to the value in the fetch request register 103, as described above.

A limit to the fetch depth, i.e. the number of lines of data to be fetched, is used, e.g. a programmable or settable limit. For example, if first and second requests are four (4) lines and the depth limit is set to six (6), fetch machine 100 ultimately fetches three (3) lines of the second request. In operation, the first line of the first request is fetched and six (6) additional lines corresponding to the depth limit are fetched; three (3) lines remaining from the first request and three (3) lines from the second request.

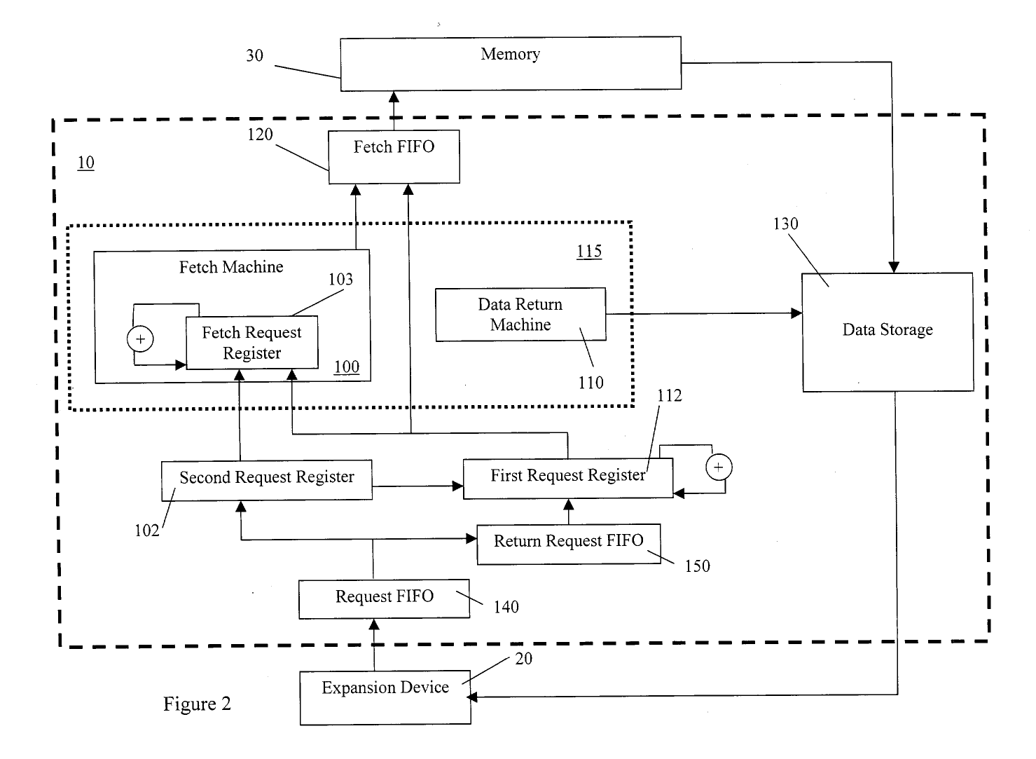

Every time a line is returned from memory 30 to expansion device 20, one additional line is fetched from the second request. The fetch depth, also referred to as a prefetch amount, e.g. six (6) in the above example, can cross multiple requests in the alternate design depicted and described in reference to FIG. 2 below. For example, if the depth limit is six (6) and a plurality of one line requests are received, the first request results in a fetch of one line and the next six (6) requests result in one line per request being fetched. In this manner, the depth limit spans multiple fetch requests. The depth limit acts as a window scrolling over the list of requests regardless of the size of an individual request.

As data returns from memory 30 to the I/O bridge chip 10, the data is stored in a data storage device 130. Data storage device 130 is a fully-associative cache. Alternatively, any other type of data storage device can be used in place of a fully-associative cache.

The data return machine 110 returns data to the expansion device 20. The data return machine 110 checks that the data corresponding to the address in the first request register 112 has been returned from memory 30 and is currently located in the data storage device 130. If these data are present, the data return machine 110 retrieves these data and removes them from the data storage device 130, and returns them to the expansion device 20.

It is possible that the next line to be returned to the expansion device 20 may have been returned from memory 30 to the I/O bridge chip 10, but is not present in the data storage device 130 at the time the next line needs to be returned to the expansion device 20. If the data in the memory location corresponding to a line in the data storage device 130 are changed after the line has been stored in the data storage device 130, but before the line has been returned to the expansion device 20, the line is removed from the data storage device 130. In this case, the data return machine 110 fetches the next line to be returned.

After the data return machine 110 returns a line to the expansion device 20, it updates the value in the first request register 112. The request length is decremented by one, and the address is set to the next line to be returned. If there are more lines in the DMA request currently being processed, this will simply entail incrementing the address to the address of the next line in memory.

Operation continues in the previously stated manner until all lines of the current request have been returned to the expansion device 20. When the data return machine 110 finishes returning a request (signaled by the length of the request in the first request register 112 reaching zero), machine 110 checks whether there is a request in the second request register 102. If there is, the request is copied from the second request register 102 into the first request register 112, and the data return machine 110 returns that DMA request to the expansion device 20.

There is a limitation to how many outstanding DMA requests between the I/O bridge chip 10 and memory 30 the system of FIG. 1 can have. The number of outstanding DMA requests is limited by the use of only one second request register 102. When there are two requests outstanding between the I/O bridge chip 10 and memory 30, a third request can not be processed with the system of FIG. 1. The first request information is held in the first request register 112. The second request information is held in the second request register 102. If either of these registers is overwritten with information for a third request, the information enabling data to be returned for the overwritten request is lost. In order to process a third outstanding request, an additional request register has to be added to store the third request information. The I/O bridge chip 10 continues operating as before. This offers one reason why the state machine 115 is not ready to process additional requests present in the queue of request FIFO 140.

In the system of FIG. 2, an additional FIFO queue, return request FIFO 150 having a queue is added. Return request FIFO 150 is connected to the first and second request registers 112 and 102. The method of operation is the same in FIG. 2 as in FIG. 1 except that in FIG. 2 when fetch machine 100 loads a request from the second request register 102 into fetch machine 100, fetch machine 100 also places a copy of the request into the queue of return request FIFO 150. When the data return machine 110 finishes returning an entire request, signaled by the length of the request in the first request register 112 reaching zero, machine 110 checks whether the return request FIFO queue 150 holds any requests. If the return request FIFO queue 150 does hold requests, the data return machine 110 removes the next request from the queue of return request FIFO 150 into first request register 112, and then returns that DMA request to the expansion device 20.

In the systems of FIGS. 1 and 2 gaps are eliminated in the data return to the expansion device 20. To do this, the systems of FIGS. 1 and 2 must be designed to fetch each data line a certain amount of time ahead of when the data line will actually be returned. To determine the exact configuration of the systems of FIGS. 1 and 2 to eliminate gaps in the data return, the system should be configured in accordance with:

$$n = \frac{{r}_{m}}{{r}_{c}} = \frac{{r}_{m}}{\frac{L}{V}}$$

where rₘ=the average memory latency, i.e., the average latency between when a fetch is made and the data are returned to the I/O bridge chip 10; r_{c}=the rate time it takes for the I/O bridge chip 10 to return each line of data from the I/O bridge chip to the expansion device 20; L=the size of a line; v=the byte transfer rate across the connection between the expansion device 20 and the I/O bridge chip 10; and n=the number of lines that the I/O bridge chip 10 should fetch ahead of their return, according to the present invention, in order to eliminate gaps in the data return.

For example, if rₘ=1000 nanoseconds/line requested from memory, L=64 bytes, and v=1 GB/second, then r_{c}=64 ns, and n=15.625 lines. In this case, I/O bridge chip 10 must fetch 16 lines ahead of the data return to eliminate gaps in the data return.

At the same time, there is a limit to how many outstanding requests can exist between the I/O bridge chip 10 and memory 30. The I/O bridge chip 10 must store, in the data storage device 130, all data returned from memory 30 out of order, which could potentially be all outstanding fetches minus one, if the first fetch takes sufficiently long to return from memory 30. Because the data storage device 130 has a finite capacity, the fetch duration time can potentially constrain the number of outstanding fetches made by the I/O bridge card 10. As such, an upper limit is placed on the number of fetches the I/O bridge card 10 can make. This offers a second explanation as to why the state machine 115 is sometimes not ready to process additional requests that are present in the queue of request FIFO 140. The I/O bridge chip 10 can not have more outstanding fetches to memory 30 than there is space in the data storage device 130.

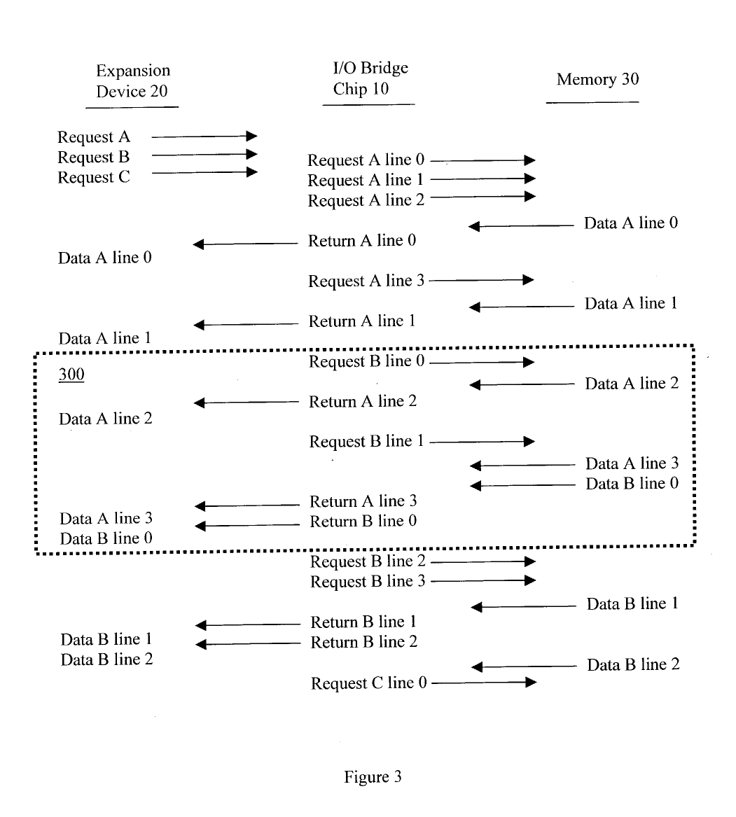

FIG. 3 depicts an example transaction sequence between expansion device 20, bridge chip 10, and memory 30. In the example transaction, three requests, i.e. A, B, and C, of four lines each are received from device 20 by chip 10. According to the above description of operation, chip 10 provides the requests to memory 30 and receives the data return from memory 30. Upon receiving the data return, chip 10 provides the data return to device 20. It is to be noted that lines are requested for request B prior to the completion of the return of all lines of data fulfilling request A, as depicted in section 300 (dotted line).

A feature of the present invention is that more data requests can be fetched from system resources by the I/O bridge chip before or while the data responsive to a first request is being returned from the system resources to the I/O bridge chip. Data can come back from the system out of order, in which case the I/O bridge chip handles data as it is returned from system resources, and insures that data are returned to the expansion device in the order expected. In this way, multiple outstanding data requests can be processed, thus hiding latency time of each request from the I/O card. The number of outstanding requests that can be processed is limited only by the storage capacity of the I/O bridge chip, which must maintain a buffer of returned memory and track outstanding requests, to ensure that data are returned to the expansion device in the order expected.

It will be readily seen by one of ordinary skill in the art that the present invention fulfills all of the aspects and advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of processing a plurality of outstanding data requests from an expansion device connected to an I/O bridge chip of a computer system, comprising:
receiving more than one data request from the expansion device, wherein each data request includes a location of the data requested and a length of data requested;
requesting data from other components in said computer system, according to each data request sent from the expansion device, wherein a request for data from other components is issued prior to completion of a prior request for data from other components;
receiving requested data from the other components by the I/O bridge chip according to data requests received by the other components from the I/O bridge chip; and
returning received requested data to the expansion device.

2. The method of claim 1, wherein said requesting of data from other components in said computer system, according to the data requests sent from the expansion device, is performed by said I/O bridge chip.

3. The method of claim 1, wherein said received requested data by the I/O bridge chip according to data requests received by the other components from the I/O bridge chip, is performed by the component of the computer system from which data were requested.

4. The method of claim 1, wherein said returning of requested data to the expansion device is performed by the I/O bridge chip.

5. The method of claim 1, wherein the expansion device is connected to the I/O bridge chip via a PCI-X bus.

6. The method of claim 1, wherein the location of at least one of the data requests from the expansion device is in main memory, and wherein said data request is a direct memory access request.

7. The method of claim 1, wherein the expansion device is an I/O card.

8. The method of claim 1, further comprising:
storing a record of each outstanding request;
storing, in a data storage device, said requested data returned from said other components to the I/O bridge chip; and
returning said requested data to said expansion device in the order in which said requested data was requested.

9. The method of claim 8, wherein said data storage device is a cache.

10. The method of claim 9, wherein said cache is a fully-associative cache.

11. An apparatus for processing a plurality of outstanding data requests from an expansion device connected to a computer system, comprising:
a processor for executing instructions causing the processor to (a) fetch data from the computer system according to each data request received from the expansion device; and
(b) return the results of each fetched data request to the expansion device, wherein data from a subsequent data request is fetched prior to the return of data for a previous data request.

12. The apparatus of claim 11, wherein said processing arrangement comprises an I/O bridge chip connecting the expansion device and the computer.

13. The apparatus of claim 11, further comprising:
a memory for storing (a) a record of each outstanding request and (b) results of each fetched data request returned from the computer system;
and wherein the processing arrangement is arranged to return said results of each fetched data request stored in the memory arrangement in the order the apparatus received said data requests from said expansion device.

14. The apparatus of claim 11, wherein said data requests are direct memory access requests.

15. The apparatus of claim 13, wherein said memory includes a cache for storing results of each fetched data request returned from the computer system out of order.

16. The apparatus of claim 15, wherein said cache is a fully-associative cache.

17. A system for use with an expansion device comprising:
a computer system adapted to be connected to the expansion device;
an I/O bridge chip for processing a plurality of outstanding data requests from the expansion device, the chip being arranged for (a) fetching data from the computer system according to each data request received from an expansion device and (b) returning the results of each fetched data request to the expansion device, wherein the I/O bridge chip fetches data from the computer system a predetermined amount of time ahead of data return and wherein the predetermined amount of time can span a plurality of data requests;
first and second ends of the I/O bridge chip being respectively physically connected to the computer system, and an expansion device bus for operating on a protocol allowing expansion devices adapted to be connected to the bus to have multiple outstanding data requests, and to specify the length of each data request sent to the computer system.

18. The system of claim 17 further including an expansion device physically connected to the expansion device bus, and logically connected to the computer system via the I/O bridge chip.

19. The system of claim 17, wherein said I/O bridge chip further comprises:
a memory arrangement for (a) storing a record of each outstanding request and (b) storing said results of each fetched data request returned from the computer system out of order;
and wherein said memory arrangement of said I/O bridge chip is arranged to return the results of each fetched data request stored in the memory arrangement in the order the I/O bridge chip received said data requests from said expansion device.

20. The system of claim 19, wherein said memory arrangement includes a cache for storing results of each fetched data request returned from the computer system out of order.
